(19) United States
(12) Patent Application Publication
(10) Pub. No.: US 2022/0198123 A1
(43) Pub. Date: Jun. 23, 2022

(54) INFORMATION PROCESSING DEVICE AND NON-TRANSITORY COMPUTER READABLE MEDIUM

(71) Applicant: FUJIFILM Business Innovation Corp., Tokyo (JP)

(72) Inventor: Takuya OKAMOTO, Kanagawa (JP)

(73) Assignee: FUJIFILM Business Innovation Corp., Tokyo (JP)

(21) Appl. No.: 17/314,175

(22) Filed: May 7, 2021

(30) Foreign Application Priority Data
Dec. 23, 2020 (JP) 2020-214227

(51) Int. Cl. G06F 40/103

(52) U.S. Cl. CPC G06F 40/103

(57) ABSTRACT

An information processing device includes a processor configure to: display, in a case where multiple files displayed on a display are selected, candidates of an attribute of a combined file generated by combining the multiple files near the selected files; and execute, in a case where the attribute is selected, a process related to the selected attribute on the combined file.

### CROSS-REFERENCE TO RELATED APPLICATIONS

This application is based on and claims priority under 35 USC 119 from Japanese Patent Application No. 2020-214227 filed Dec. 23, 2020.

### BACKGROUND

### (i) Technical Field

The present disclosure relates to an information processing device and a non-transitory computer readable medium.

### (ii) Related Art

Technology that combines multiple files to generate a combined file is known. Also, in some cases, an attribute of the combined file (such as the file format or storage location of the combined file, for example) is selected by the user, and a process related to the selected attribute (for example, converting the file format or storing the combined file in the storage location) is executed.

Japanese Unexamined Patent Application Publication No. 2007-42092 describes a device that converts pages of a document to an appropriate format when selecting pages of a document to add to a binder document.

Japanese Patent No. 5514830 describes a system that chooses a type of object selected in a GUI system, specifies functions related to the object, and displays a menu icon related to the functions near the object when the object is dragged and dropped.

### SUMMARY

By the way, it is conceivable to display attribute candidates for a combined file at a predetermined fixed position on a display, irrespectively of the display position on the display of the files to be combined, and in the case where an attribute is selected by the user from among the attribute candidates, a process related to the selected attribute is executed.

Aspects of non-limiting embodiments of the present disclosure relate to, in the case of executing a process related to an attribute of a combined file generated by combining multiple files, reducing the number of work steps by the user for executing the process related to the attribute compared to the case where the user is made to select an attribute from among attribute candidates are displayed at a predetermined fixed position irrespectively of the display position on the display of the files to be combined.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to: display, in a case where multiple files displayed on a display are selected, candidates of an attribute of a combined file generated by combining the multiple files near the selected files; and execute, in a case where the attribute is selected, a process related to the selected attribute on the combined file.

### BRIEF DESCRIPTION OF THE DRAWINGS

An exemplary embodiment of the present disclosure will be described in detail based on the following figures, wherein:

FIG. 1 is a block diagram illustrating a configuration of an information processing system according to an exemplary embodiment;

FIG. 2 is a block diagram illustrating a configuration of a terminal device according to the exemplary embodiment;

FIG. 3 is a flowchart illustrating a flow of processes according to the exemplary embodiment;

FIG. 4 is a diagram illustrating a screen;

FIG. 5 is a diagram illustrating a screen;

FIG. 6 is a diagram illustrating a screen;

FIG. 7 is a diagram illustrating a screen;

FIG. 8 is a diagram illustrating a screen;

FIG. 9 is a diagram illustrating explanatory text about a file format candidate;

FIG. 10 is a diagram illustrating a warning;

FIG. 11 is a diagram illustrating a screen;

FIG. 12 is a diagram illustrating a screen;

FIG. 13 is a diagram illustrating a screen;

FIG. 14 is a diagram illustrating a screen;

FIG. 15 is a diagram illustrating explanatory text about storage locations;

FIG. 16 is a diagram illustrating a structure of a storage location;

FIG. 17 is a diagram illustrating a screen;

FIG. 18 is a diagram illustrating a screen;

FIG. 19 is a diagram illustrating a screen;

FIG. 20 is a diagram illustrating a screen;

FIG. 21 is a diagram illustrating a screen; and

FIG. 22 is a diagram illustrating a screen.

### DETAILED DESCRIPTION

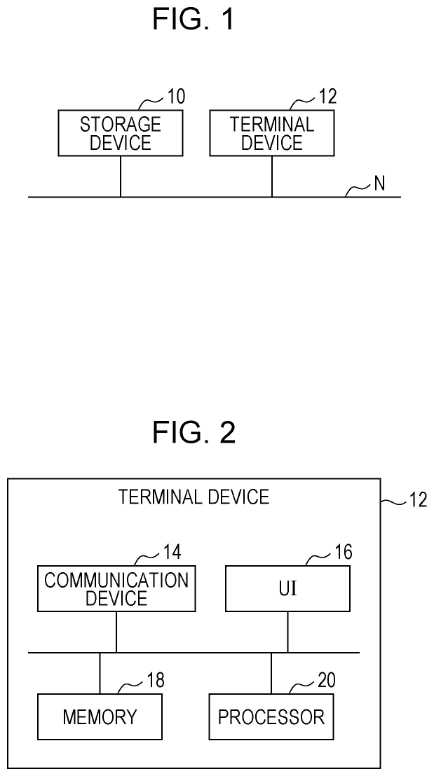

An information processing system according to the exemplary embodiment will be described with reference to FIG. 1. FIG. 1 illustrates an example of the configuration of the information processing system according to the exemplary embodiment.

The information processing system according to the exemplary embodiment includes a storage device 10 and a terminal device 12 as an example. The numbers of the storage device 10 and the terminal device 12 illustrated in FIG. 1 are merely an example, and multiple storage devices 10 and multiple terminal devices 12 may also be included in the information processing system.

The storage device 10 is a device that stores files. For example, the storage device 10 may be local storage, network storage, or online storage. For example, the storage device 10 and the terminal device 12 may be connected to a communication channel N such as a network, and files may be transmitted and received between the storage device 10 and the terminal device 12. Furthermore, the storage device 10 may also be included in the terminal device 12.

Examples of files include document files (such as text files, rich text files, PDF, and xdw files), image files (such as image files in a bitmap format and image files in a vector format), video files (such as mpeg files), audio files (such as mp3 files), spreadsheet files, compressed files (such as files in zip format), source files (such as files in html format), executable files (such as exe files), program files, and system files. Obviously, information such as data and datasets in file formats other than the above may also be included in the scope of the concept of files according to the exemplary embodiment.

The terminal device 12 is a device such as a personal computer (hereinafter referred to as a “PC”), a tablet PC, a smartphone, or a mobile phone, for example. Files are edited and managed by the terminal device 12. Additionally, files may also be stored in the terminal device 12.

Hereinafter, FIG. 2 will be referenced to describe a hardware configuration of the terminal device 12. FIG. 2 illustrates an example of the hardware configuration of the terminal device 12.

The terminal device 12 includes a communication device 14, a user interface (UI) 16, memory 18, and a processor 20, for example.

The communication device 14 is a communication interface including components such as a communication chip and a communication circuit, and has a function of transmitting information to another device and a function of receiving information from another device. The communication device 14 may have a wireless communication function, and may also have a wired communication function.

The UI 16 is a user interface, and includes at least one of a display and an operation device. The display is a display device such as a liquid crystal display (LCD) or an electroluminescence (EL) display. The operation device is a device such as a keyboard, input keys, or a control panel. The UI 16 may also be a UI such as a touch panel combining a display with an operation device.

The memory 18 is a device that establishes one or multiple storage areas that store various types of information. For example, the memory 18 is a hard disk drive, any of various types of memory (such as RAM, DRAM, or ROM, for example), another type of storage device (such as an optical disc, for example), or a combination of the above. One or multiple memories 18 are included in the terminal device 12. Files may be stored in the memory 18.

The processor 20 is configured to control the operation of each component of the terminal device 12. The processor 20 may include memory.

In the exemplary embodiment, in the case where multiple files are being displayed on the display of the UI 16, and multiple files being displayed on the display are selected, the processor 20 displays attribute candidates for a combined file generated by combining the selected multiple files near the selected files. Additionally, in the case where an attribute is selected from among the attribute candidates, the processor 20 executes a process related to the selected attribute on the combined file. The selection of the files and the selection of the attribute are performed by the user.

Examples of being near a file include a position overlapping an image of the file (such as an icon or typical image representing the file), a position that is a predetermined distance away from an image of the file (such as a position a slight distance such as a few pixels away), a region where there is no other image between the display position of the attribute candidates and the image of the file, a region between the image of the file and the image of an adjacent file in the case where the display positions of the images of files are arranged automatically, or a region overlapping the image of an adjacent file.

The attributes of a file are the file format, the storage location of the file, or a combination of both.

Examples of file formats include document file formats, image file formats, audio file formats, spreadsheet file formats, compressed file formats, source file formats, program file formats, and system file formats. For example, document file formats include multiple types of file formats (such as the text file format, the PDF format, and the xdw file format). The same applies to other file formats.

The storage location is a storage area or a storage device where a file is stored. The storage location exists in the storage device 10, the terminal device 12, or another device. The storage location may be a location such as a folder or directory for managing and organizing files by grouping files together, or the storage location may be the storage device itself.

In the case where the attribute is a file format, the process related to the attribute is the conversion of the file format. As an example, a case will be described in which a document file 1 and a document file 2 having different document file formats are selected by the user as files to be combined, a file format is selected by the user from among file format candidates, and the document file 1 and the document file 2 are combined. In this case, the processor 20 executes the following conversion process 1 and conversion process 2. The conversion process 1 is a process that converts the file format of each of the document file 1 and the document file 2 into a selected file format, and then combines the document file 1 and the document file 2. The conversion process 2 is a process that combines the document file 1 and the document file 2, and then converts the file format into the selected file format. The execution of either of the conversion processes 1 and 2 corresponds to executing a process related to the attribute of the combined file (that is, conversion of the file format) on the combined file.

In the case where the attribute is a storage location, the process related to the attribute is the storage of the combined file in the storage location. Storage refers to causing a file to be stored in a storage area or a storage device acting as the storage location. For example, in the case where a storage location is selected by the user from among storage location candidates, the processor 20 stores the combined file in the selected storage location.

The combining of multiple files may be, for example, merging multiple files into a single file without maintaining the independence of each of the multiple files to be combined (in other words, merging the files into a single file such that the files to be combined are no longer individually distinguishable), or merging multiple files into a single file while maintaining the independence of each file such that each file is distinguishable.

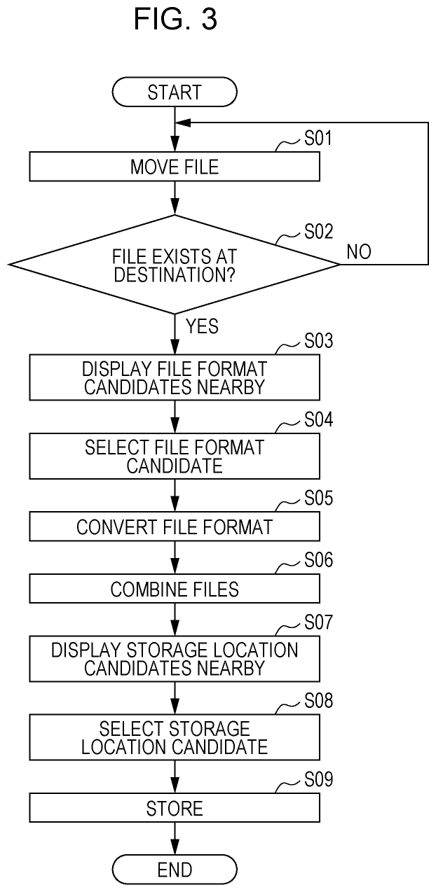

Hereinafter, FIG. 3 will be referenced to describe processes according to the exemplary embodiment. FIG. 3 is a flowchart illustrating a flow of processes according to the exemplary embodiment.

Images of multiple files are displayed on the display of the UI 16, and the user moves an image of a files to be combined (S01). For example, the user drags the image of a file to be combined. In the following description, the file that is moved in this way is referred to as the “first file” for convenience.

In the case where another file exists at the destination of the first file (S02, Yes), the processor 20 causes candidates of the file format of the combined file to be displayed near the image of the other file on the display (S03). In the following description, the other file is referred to as the “second file” for convenience. For example, in the case where the user drags the image of the first file to a position overlapping the image of the second file (for example, in the case where all or part of the image of the first file is superimposed over the image of the second file), in the case where a mouse cursor used for the drag operation overlaps the image of the second file, or in the case where the distance between the image of the first file and the image of the second file on the display is a threshold value or less, the processor 20 treats the second file as existing at the destination of the first file, and displays file format candidates near the image of the second file. By this operation, the second file to be combined with the first file is selected. In the case where another file does not exist at the destination of the first file (S02, No), the process returns to step S01.

In step S03, the processor 20 causes images representing the file format candidates (such as icons or typical images, for example), character strings expressing the file format candidates, or a combination of both, to be displayed on the display. The processor 20 may change the display order of the file format candidates according to the file formats of the first file and the second file, or change the display order of the file format candidates according to the presence or absence of file attribute information indicating the file attributes of each of the first file and the second file. The file attribute information corresponds to an example of file-related information. Examples of file attributes include the creator of the file, the type of file, the file format, the name of a program for editing or displaying the file, the storage location of the file, the file size (that is, volume), the date and time when the file was created, the date and time when the file was last modified, and the date and time when the file was last accessed. At least one of the above corresponds to the file attributes.

Next, the user selects an intended file format from among the file format candidates (S04). For example, if the user drops the image of the first file onto an image representing the intended file format from among the file format candidates, the intended file format is selected. As another example, the image of the first file and the image of the second file may be collected into a single image, and the user may drop the single image onto an image representing the intended file format.

If the intended file format is selected, the processor 20 converts the file format of each of the first file and the second file to the intended file format (S05), and combines the first file and the second file (S06). With this arrangement, a combined file in the intended file format is generated. The processes in steps S05 and S06 may be the conversion process 1 or the conversion process 2 described above. Note that the user may also select the intended file format after dropping the image of the first file onto the image of the second file.

After the combined file is generated, an image of the combined file is displayed at or near the display position of the image of the second file. Note that in the case where the first file and the second file are combined to generate the combined file, the first file and the second file may be deleted, or may be allowed to remain without being deleted.

Next, the processor 20 causes candidates of the storage location of the combined file to be displayed near the image of the combined file on the display (S07). The processor 20 causes images representing the storage location candidates (such as icons or typical images representing folders, for example), character strings expressing the storage location candidates, or a combination of both, to be displayed on the display.

If the user selects an intended storage location from among the storage location candidates (S08), the processor 20 stores the combined file in the intended storage location (S09). For example, the user may select an icon representing the intended storage location with a mouse or the like, or select the intended storage by dragging and dropping the combined file onto an icon representing the intended storage location. Note that the processor 20 may also change the storage location candidates and their display order according to properties such as the names or usage frequency of the storage locations.

Hereinafter, a specific example will be given to describe processes according to the exemplary embodiment.

As an example, the following describes the case of combining a document file A stored in a folder A and a document file B stored in a folder B. The document files A and B are stored in respectively different folders, but obviously the multiple document files to be combined (for example, the document files A and B) may also be stored in the same folder. Additionally, the document files A and B are assumed to have the same document file format (for example, xdw format). Obviously, the document files A and B may also be different document file formats.

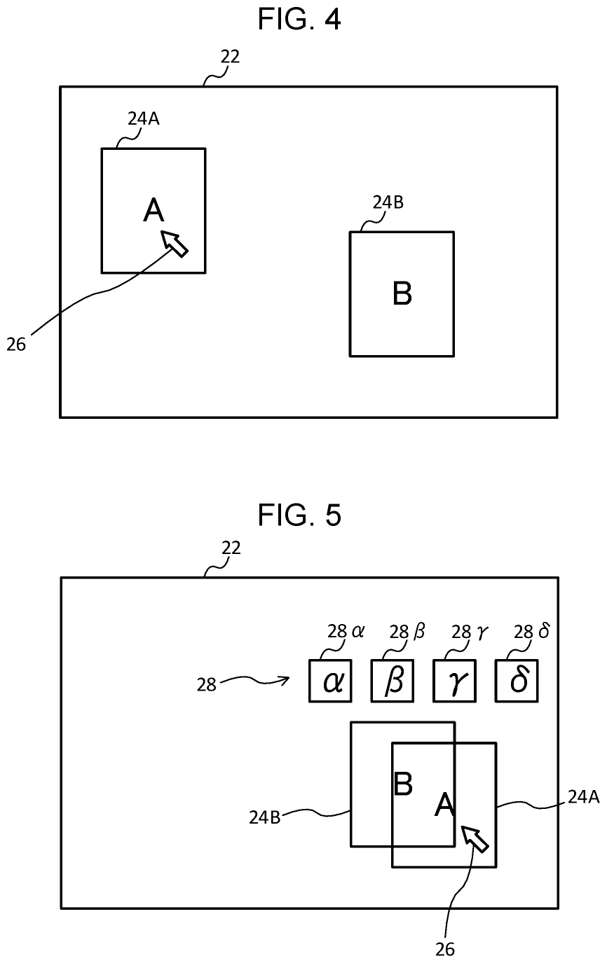

FIGS. 4 to 8 illustrate a screen 22 on the display of the UI 16. On the screen 2, an image 24A (for example, an icon) of the document file A and an image 24B (for example, an icon) of the document file B are displayed. Also, a cursor 26 (for example, a mouse cursor) used to perform operations on objects such as document files is displayed. Note that in the case where document files are managed by file manager software or the like, if the file manager software is launched, a screen for the file manager software is displayed, and operations and the like are performed on the document files A and B on the screen.

For example, if the user operates the cursor 26 to specify the image 24A of the document file A (by clicking the mouse, for example), as illustrated in FIG. 4, and moves the image 24A to the image 24B of the document file B, as illustrated in FIG. 5, the processor 20 displays a candidate group 28 of file formats of the combined file near the image 24B of the document file B.

For example, the processor 20 displays the candidate group 28 of file formats in the case where the user drags the image 24A of the document file A to a position overlapping the image 24B of the document file B. In the example illustrated in FIG. 5, the images 24A and 24B partially overlap each other, and the processor 20 displays the candidate group 28 in the case where the size or ratio of the overlapping portion is a threshold value or greater. The processor 20 may display the candidate group 28 in the case where the image 24A is dropped onto the image 24B, but may also display the candidate group 28 even if the image 24A is not dropped onto the image 24B.

As another example, the processor 20 may also display the candidate group 28 in the case where the cursor 26 overlaps the image 24B or in the case where the distance between the image 24A and the image 24B is a threshold value or less.

In the example illustrated in FIG. 5, the candidate group 28 is displayed at a position not overlapping the image 24B. For example, the candidate group 28 is displayed at a position that is a predetermined distance away (for example, a position that is a few pixels away) from the image 24B.

The candidate group 28 includes multiple candidates of the file format of the combined file, and an image (such as an icon, for example) expressing each candidate is displayed near the image 24B.

For example, the candidate group 28 of file formats includes a file format α, a file format β, a file format y, and a file format δ. An image 28α is an image representing the file format α. An image 28β is an image representing the file format β. An image 28γ is an image representing the file format γ. An image 28δ is an image representing the file format δ. For example, the images 28α, 28γ, 28γ, and 28δ are displayed next to each other.

Each file format candidate included in the candidate group 28 is a file format obtainable by converting from the file format of each of the document files A and B to be combined. For example, file formats that are compatible with the file format of each of the document files A and B are included in the candidate group 28 as candidates of the file format of the combined file. Document file formats that are the same or different from the file format of each of the document files A and B, image file formats, and the like are included in the candidate group 28.

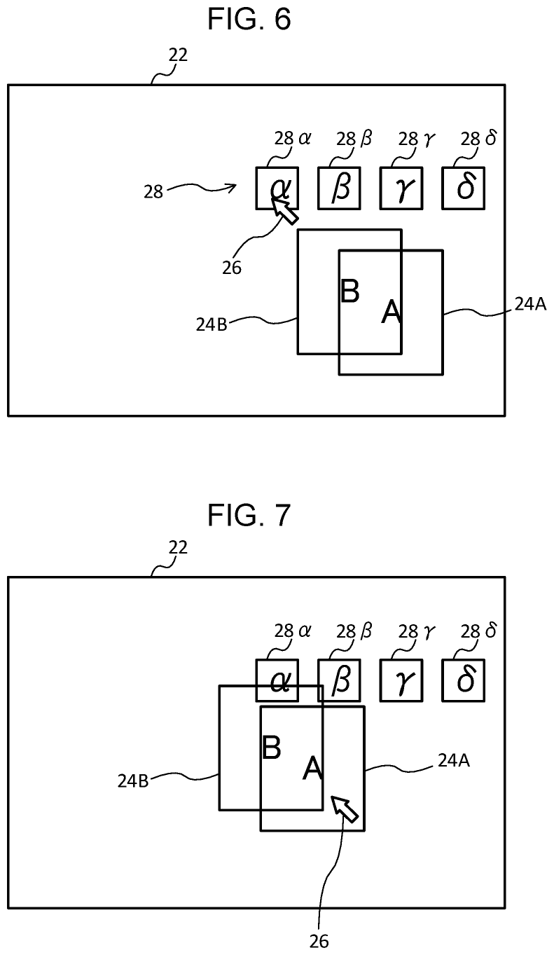

Next, the user selects the intended file format from the candidate group 28. As illustrated in FIG. 6 for example, the user selects the intended file format by operating the cursor 26 and specifying the image representing the intended file format with the cursor 26. For example, after dropping the image 24A onto the image 24B, the user specifies the image representing the intended file format with the cursor 26. In the example illustrated in FIG. 6, the image 28α is specified (clicked, for example) by the cursor 26, thereby selecting the file format a.

As another example, as illustrated in FIG. 7, the images 24A and 24B are treated as a single image (for example, the images 24A and 24B are merged), and the user selects the intended file format by using the cursor 26 to move the single image to the image representing the intended file format. For example, the intended file format is selected if the center position or an edge of the single image is moved to the image representing the intended file format (for example, the center position or edge is made to overlap the image representing the file format), and then the single image is dropped onto the image representing the intended file format, or even if the single image is not dropped. In the case where the user causes the image 24A to overlap the image 24B without dropping the image 24A onto the image 24B, the images 24A and 24B may be treated as a single image and the single image may be moved by the user, or in the case where the user drops the image 24A onto the image 24B, the images 24A and 24B are treated as a single image and the single image may be moved by the user.

As yet another example, the user may select the intended file format by moving the image 24A expressing the document file A to the image representing the intended file format. For example, the intended file format is selected if the center position or an edge of the image 24A is moved to the image representing the intended file format. For example, the user selects the intended file format by causing the image 24A to overlap the image 24B without dropping the image 24A onto the image 24B, and then moving the image 24A to the image representing the intended file format. The intended file format may also be selected in the case where the images 24 are dropped onto the image expressing the intended file format.

In other words, the intended file format may be selected in the case where the image 24A of the document file A is dragged to the image 24B of the document file B, and then the image 24A is not dropped onto the image 24B but dragged farther onto an image representing the intended file format. Alternatively, the intended file format may be selected after dropping the image 24A onto the image 24B, or the intended file format may be selected in the case where the images 24A and 24B are merged and then dragged and dropped onto the image representing the intended file format.

If the intended file format is selected by the user, the processor 20 combines the document files A and B to generate a combined file in the intended file format. For example, in the case where the file format a is selected, the processor 20 combines the document files a and B to generate a combined file in the file format a. Hereinafter, the combined file generated by combining the document files A and B will be referred to as the “combined file AB”.

The processor 20 generates the combined file AB in the file format a by executing the conversion process 1 or the conversion process 2 described above.

According to the conversion process 1, the processor 20 converts the file format of each of the document file A and the document file B to the file format a, and then combines the document file A and the document file B to generate the combined file AB.

According to the conversion process 2, the processor 20 combines the document file A and the document file B to generate a single document file, and then converts the file format of the single document to the file format a to generate the combined file AB.

For example, in the case where the document files A and B are document files in the xdw format, and the intended file format a is the PDF format, the combined file AB is generated as a file in the PDF format by the above conversion processes.

Note that in the case where file format conversion is unnecessary, the processor 20 combines the document file A and the document file B without converting the file format. For example, in the case where the document files A and B are both in the same file format α and the intended file format is the file format α, converting the file format is unnecessary for both the document files A and B, and consequently the processor 20 combines the document file A and the document file B to generate the combined file AB without executing a process of converting the file format.

In the case of converting the file format of only one of the document files (for example, the document file A), the processor 20 converts the file format of the document file A to the intended file format α, and then combines the document file A and the document file B. For example, in the case where the document file A is a document file in the file format β, the document file B is a document file in the file format α, and the intended file format is the file format α, the file format β of the document file A is converted to the file format α, and the document file A whose file format has been converted to the file format α is combined with the document file B.

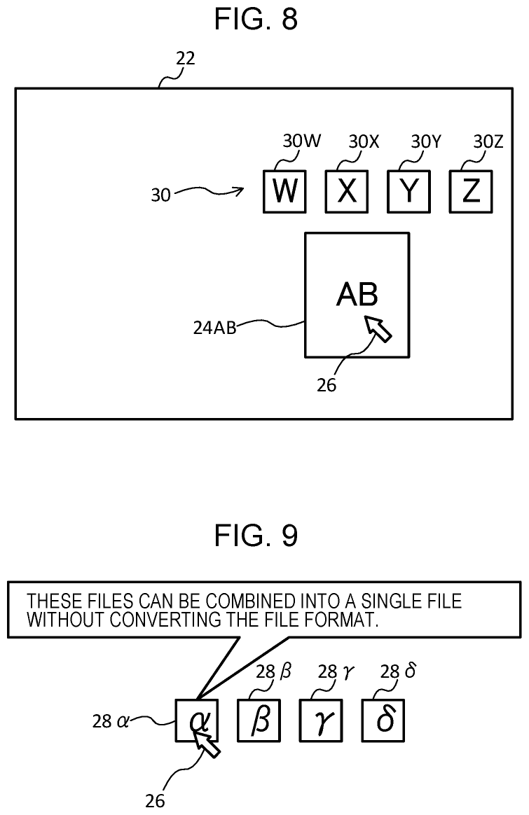

FIG. 8 illustrates an image 24AB (for example, an icon) representing the combined file AB. After the combined file AB is generated, the processor 20 displays a candidate group 30 of storage locations of the combined file near the image 24AB of the combined file AB.

The candidate group 30 includes multiple candidates of the storage location of the combined file, and an image (such as an icon, for example) expressing each candidate is displayed near the image 24B.

For example, the candidate group 30 of storage locations includes a storage location W, a storage location X, a storage location Y, and a storage location Z. An image 30W is an image representing the storage location W. An image 30X is an image representing the storage location X. An image 30Y is an image representing the storage location Y. An image 30Z is an image representing the storage location Z. For example, the images 30W, 30X, 30Y, and 30Z are displayed next to each other.

Next, the user selects an intended storage location from the candidate group 28. For example, the user selects the intended storage location by operating the cursor 26 and specifying (such as by clicking, for example) the image represented the intended storage location with the cursor 26.

As another example, the user may select the intended storage location by moving the image 24AB to the image representing the intended storage location. For example, the user may select the intended storage location by dragging and dropping the image 24AB onto the image representing the intended storage location.

If the intended storage location is selected by the user, the processor 20 stores the combined file AB in the selected storage location.

Note that the filename of the combined file AB may be the filename of the document A that was selected initially, the filename of the document file B that was selected finally, an automatically determined filename different from the filenames of the document files A and B, or a filename newly given by the user.

Explanatory text about the file format candidates and explanatory text about the storage location candidates may also be displayed.

FIG. 9 illustrates an example of explanatory text about a file format candidate. For example, if the user specifies an image representing a file format candidate with the cursor 26, the processor 20 displays explanatory text about the specified file format candidate. In the example illustrated in FIG. 9, the file format α has been specified by the user, and therefore explanatory text about the file format α is displayed. For example, a sentence explaining that the file format α is a file format that can merge multiple files to be combined into a single file without converting the file format is displayed. The same applies to other file formats. The same also applies to storage location candidates.

In the examples illustrated in FIGS. 4 to 8, the candidate group 28 of file formats is displayed before the candidate group 30 of storage locations, and the candidate group 30 of storage locations is displayed after a file format is selected and a combined file is generated.

As another example, the candidate group 30 of storage locations may be displayed before the candidate group 28 of file formats (for example, the candidate group 30 of storage locations may be displayed after multiple files to be combined (for example, the document files A and B) are selected), the candidate group 28 of file formats may be displayed after a storage location candidate is selected, and in the case where a file format is selected, a combined file in the selected file format may be generated, and the combined file may be stored in the selected storage location.

As yet another example, a file format may be selected from the candidate group 28 of file formats after multiple files to be combined are selected, and in the case where a storage location is selected from the candidate group 30 of storage locations, a combined file in the selected file format may be generated, and the combined file may be stored in the selected storage location.

Note that although the process of combining multiple files to generate a combined file is executed, the process of storing the combined file does not have to be executed. For example, in the example illustrated in FIG. 8, the candidate group 30 of storage locations does not have to be displayed after the combined file is generated. (Specific examples of file formats)

Hereinafter, specific examples of file formats will be described. The specific examples described here are merely examples, and the processes according to the exemplary embodiment are also applicable to file formats other than the specific examples described here.

The file format according to Specific Example 1 is a format that merges multiple files into a single file without maintaining the independence of each of the multiple files. For example, merging the document file A and the document file B creates a completely singular document file (that is, the combined file AB). In the combined file AB, there is no distinction between the document files A and B, and the file attribute information of one of the document files A and B is lost. For example, in the case where the image of the document file A is overlapped with the image of the document file B to combine the document files A and B, the file attribute information of the document file B is lost, and the file attribute information of the document file A is attached to the combined file AB as the file attribute information of the combined file AB. Obviously, the file attribute information of the document file A may also be lost, and the file attribute information of the document file B may be attached to the combined file AB as the file attribute information of the combined file AB. Note that the file attribute information of the document file A may also be lost, and the file attribute information of the document file B may be attached to the combined file AB as the file attribute information of the combined file AB. Also, the date and time of file combination, identification information of the combined document files A and B, and the like may be included in the file attribute information of the combined file AB.

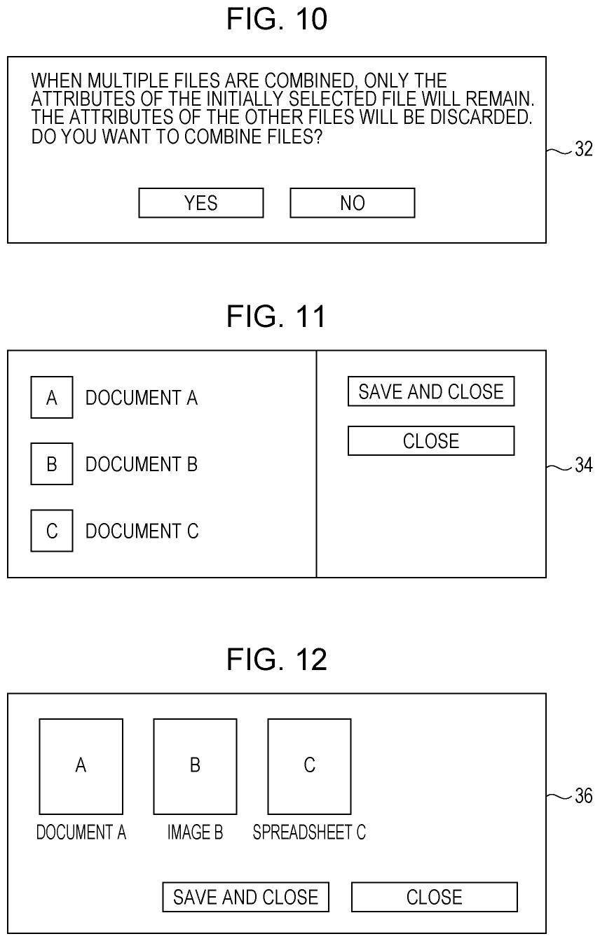

In the above example of Specific Example 1, in the case where the file attribute information of the document file B is lost, a warning indicating the loss of file attribute information may be displayed. FIG. 10 illustrates a display example of such a warning 32. For example, the message displayed as the warning 32 indicates that only the file attributes of the initially selected file will remain, and the file attributes of the other file will be discarded is displayed as the warning 32. For example, if a “Yes” button is pressed by the user, the document files A and B are combined into a single document file, and the file attribute information of the document file A is attached to the combined file AB as the file attribute information of the combined file AB. If a “No” button is pressed by the user, the combining of files is not executed.

The file format according to Specific Example 2 is a format that merges multiple files into a single file while maintaining the independence of each of the multiple files in the same file format. For example, in the case where document files A, B, and C are combined to generate a single combined file ABC, the document files A, B, and C are included independently in the combined file ABC, and the document files A, B, and C may be displayed and edited individually. The document files A, B, and C are distinguished even after being combined, and none of the file attribute information of each of the document files A, B, and C is lost.

FIG. 11 illustrates a screen 34 for managing the combined file ABC in Specific Example 2. On the screen 34, the document files A, B, and C are displayed independently, and the document files A, B, and C may be selected and edited or displayed separately. The file attribute information of each of the document files A, B, and C is maintained.

The file format according to Specific Example 3 is a file format that merges multiple files into a single file while maintaining the independence of each of the multiple files to be combined, irrespectively of the file format of each of the files to be combined. For example, in the case where a document file A, an image file B, and a spreadsheet file C are combined to generate a single combined file ABC, the document file A, the image file B, and the spreadsheet file C are included independently in the combined file ABC, and the document file A, the image file B, and the spreadsheet file C may be displayed and edited individually. The document file A, the image file B, and the spreadsheet file C are distinguished even after being combined, and none of the file attribute information of each of the document file A, the image file B, and the spreadsheet file C is lost.

FIG. 12 illustrates a screen 36 for managing the combined file ABC in Specific Example 3. On the screen 36, the document file A, the image file B, and the spreadsheet file C are displayed independently, and the document file A, the image file B, and the spreadsheet file C may be selected and edited or displayed separately. The file attribute information of each of the document file A, the image file B, and the spreadsheet file C is maintained.

(Exemplary Modification 1)

Hereinafter, Exemplary Modification 1 will be described.

In Exemplary Modification 1, the processor 20 changes the candidates of the file format of the combined file according to the file format of each of the multiple files to be combined.

For example, in the case where the respective file formats of the multiple files to be combined are different, the processor 20 causes the display to display information indicating a file format that will merge the multiple files while maintaining the file format of each of the multiple files as information indicating a candidate of the file format of the combined file.

To explain in terms of a specific example, in the case of combining a document file A and a spreadsheet file B, the processor 20 displays the file format of Specific Example 3 described above as a candidate of the file format of the combined file. In other words, the processor 20 displays a file format capable of merging the document file A and the spreadsheet file B into a combined file without converting the file format of each of the document file A and the spreadsheet file B as a candidate of the file format of the combined file.

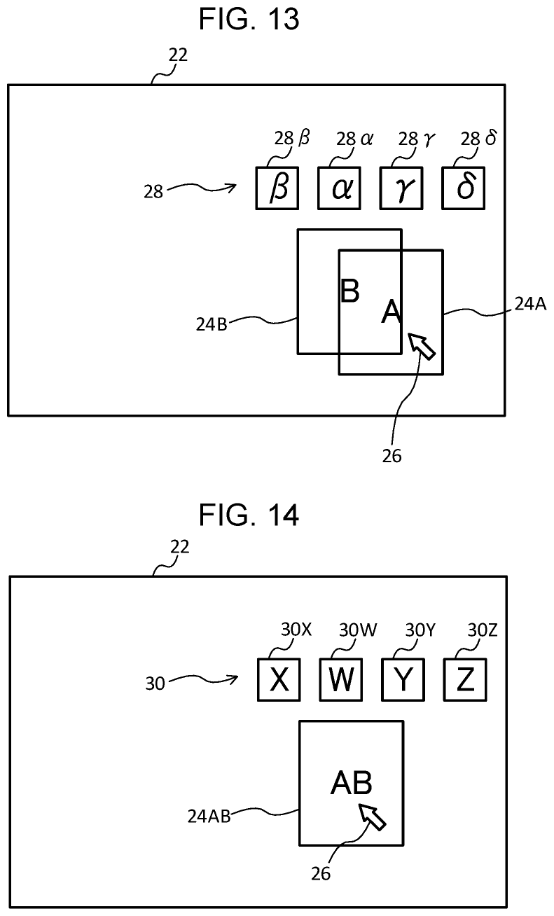

Additionally, the processor 20 may also change the display order of the candidates of the file format of the combined file. For example, the processor 20 displays each candidate according to priority. FIG. 13 illustrates an example of such a display. For example, the file format candidates included in the candidate group 28 are arranged and displayed according to priority. For example, the file format candidates are displayed next to each other in a horizontal row, with higher-priority candidates being placed farther on the left side of the row. The file format β represented by the image 28β is the file format of Specific Example 3 described above. In the case of combining the document file A and the spreadsheet file B, the processor 20 displays the image 28β representing the file format β at the position farthest on the left side of the row as the image of the highest-priority candidate, as illustrated in FIG. 13. Compared to the example illustrated in FIG. 5, the display order of the candidates has changed. In this way, the processor 20 changes the recommendation order of the file format candidates according to the file formats of the multiple files to be combined, and prioritizes the display of the file format of Specific Example 3. Note that the processor 20 may also display explanatory text about the prioritized candidate. For example, the processor 20 displays the explanatory text illustrated in FIG. 9.

In the case where the respective file formats of the multiple files to be combined are the same, the processor 20 causes the display to display information indicating a file format that will merge the multiple files into a single file as information indicating a candidate of the file format of the combined file. For example, the processor 20 displays the file format of Specific Example 1 or Specific Example 2 described above as a candidate of the file format of the combined file. In other words, the processor 20 may display a file format that does not maintain the independence of each file as a candidate of the combined file, or display a file format that maintains the independence of each file as a candidate of the combined file. Additionally, the processor 20 may display the file format of Specific Example 1 or Specific Example 2 as the highest-priority candidate. For example, the processor 20 displays an image of the file format of Specific Example 1 or Specific Example 2 at the position farthest on the left side among the candidate group 28. For example, in the case of combining the document files A and B, the processor 20 prioritizes the display of the file format of Specific Example 1 or Specific Example 2 as a candidate of the file format of the combined file.

The processor 20 may also change the file format of the combined file according to whether or not file attribute information is attached to each of the multiple files to be combined.

For example, in the case where file attribute information is attached to each of the multiple files to be combined, the processor 20 causes the display to display information indicating a file format in which the file attribute information of one file is not overwritten by the file attribute information of another file as information indicating a candidate of the file format of the combined file. For example, in the case where file attribute information is attached to each of the document files A and B to be combined, the processor 20 displays the file format of Specific Example 2 or Specific Example 3 described above as a candidate of the file format of the combined file. Additionally, the processor 20 may display the file format of Specific Example 2 or Specific Example 3 as the highest-priority candidate. For example, the processor 20 displays an image of the file format of Specific Example 2 or

Specific Example 3 at the position farthest on the left side among the candidate group 28. For example, in the case of combining the document files A and B, the processor 20 prioritizes the display of the file format of Specific Example 2 or Specific Example 3 as a candidate of the file format of the combined file.

As another example, the processor 20 may also manage a usage history of the file format of the combined file, and display candidates of the file format of the combined file arranged in order of highest usage frequency (for example, in order of the most times used). To explain in terms of the example illustrated in FIG. 5, the file format α, the file format β, the file format γ, and the file format δ are displayed next to each other in order of the usage frequency of each file format, in which the file format α has the highest usage frequency and the file format δ has the lowest usage frequency.

The processor 20 may also display file formats whose usage frequency (for example, the number of times used) is a threshold value or higher as candidates of the file format of the combined file.

Also, the user may be allowed to manually change the display order of the candidates of the file format of the combined file, or the user may be allowed to manually switch between displaying or hiding each file format candidate of the file format.

(Exemplary Modification 2)

Hereinafter, Exemplary Modification 2 will be described.

In Exemplary Modification 2, the processor 20 changes the candidates of the storage location of the combined file according to the name of a file to be combined. For example, the processor 20 displays a storage location where files having the same or similar names to the name of a file to be combined are stored as a candidate of the storage location of the combined file. To explain in terms of a specific example, in the case where the character string “invoice” is included in the name of a document file A to be combined, the processor 20 displays a storage location where files having names that include the character string “invoice” are stored as a candidate of the storage location of the combined file to be generated by combining the document file A with another file. The processor 20 may also display a storage location (for example, a folder) having a name that includes the character string “invoice” as a candidate of the storage location of the combined file.

Additionally, the processor 20 may also change the display order of the candidates of the storage location of the combined file. For example, the processor 20 displays each candidate according to priority. FIG. 14 illustrates an example of such a display. For example, the storage location candidates included in the candidate group 30 are arranged and displayed according to priority. For example, the storage location candidates are displayed next to each other in a horizontal row, with higher-priority candidates being placed farther on the left side of the row. A storage location X represented by an image 30X is a storage location where files having names similar to the name of the file to be combined are stored. In this way, the processor 20 displays the image 30X representing the storage location X at the position farthest on the left side of the row as the image of the highest-priority candidate. Compared to the example illustrated in FIG. 8, the display order of the candidates has changed. In this way, the processor 20 displays recommended storage location candidates in an order changed according to the name of a file to be combined. The processor 20 may also prioritize the display of a storage location where a predetermined number or more of files having the same or similar names to the name of a file to be combined are stored.

As another example, the processor 20 may also display a storage location where a file to be combined is stored as a candidate of the storage location of the combined file. Additionally, the processor 20 may also prioritize the display of such a storage location candidate.

As yet another example, the processor 20 may also manage a usage history of the storage location, and display candidates of the storage location of the combined file arranged in order or highest usage frequency (for example, in order of the most times used). To explain in terms of the example illustrated in FIG. 8, the storage location W, the storage location X, the storage location Y, and the storage location Z are displayed next to each other in order of the usage frequency of each storage location, in which the storage location W has the highest usage frequency and the storage location Z has the lowest usage frequency.

The processor 20 may also display storage locations whose usage frequency (for example, the number of times used) is a threshold value or higher as candidates of the storage location of the combined file.

The processor 20 may also create a new storage location where the combined file may be stored, and display the new storage location as a candidate. Also, in the case where the user gives an instruction to create a new storage location, the processor 20 may create the new storage location and store the combined file in the new storage location.

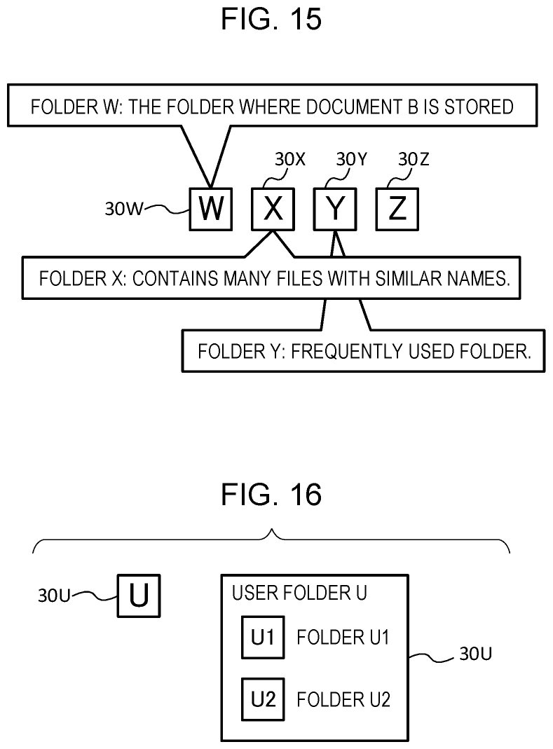

In addition, the processor 20 may also display explanatory text about each storage location candidate. FIG. 15 illustrates an example of such a display. For example, the storage location W is a storage location where a document file B to be combined is stored. The storage location X is a storage location where many files having similar names to a document file to be combined are stored (for example, a storage location where a number of files equal to or greater than a threshold are stored). The storage location Y is a frequently used storage location (for example, a storage location having a usage frequency equal to or greater than a threshold). For example, if the user specifies an image representing a storage location candidate, the processor 20 displays explanatory text about the specified candidate.

Also, in the case where a storage location candidate has a hierarchical structure, and the user specifies the storage location candidate, the processor 20 may display the hierarchical structure. For example, as illustrated in FIG. 16, a user folder U given as one example of a storage location contains separate folders U1 and U2. An image 30U (for example, an icon) representing the user folder U is displayed as an image representing a candidate of the storage location of the combined file, and if the user specifies the image 30U, the processor 20 displays images representing each of the folders U1 and U2 contained in the user folder U. For example, if the user specifies the folder U1, the processor 20 stores the combined file in the folder U1.

(Exemplary Modification of Display Timing for Candidates of Attribute)

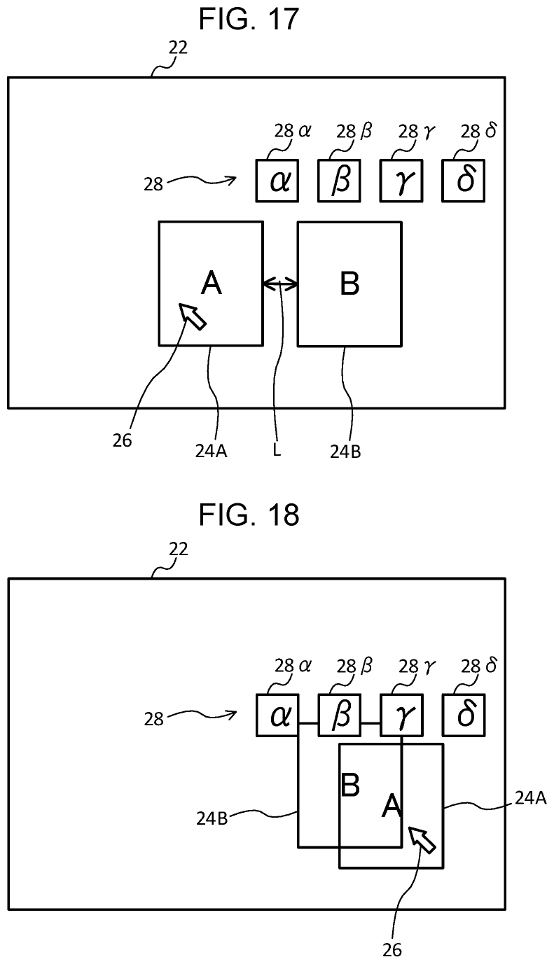

Hereinafter, FIG. 17 will be referenced to describe an exemplary modification of the timing at which file format candidates and storage location candidates are displayed. For example, in the case where the image 24A of the file A on the screen 22 is moved by the user and the distance L between the image 24A of the file A and the image 24B of the file B becomes a threshold or less, the processor 20 displays the candidate group 28. The distance L may be, for example, the shortest distance between the image 24A and the image 24B (such as the distance between the edge of the image 24A closest to the image 24B and the edge of the image 24B closest to the image 24A), or the distance between a reference position (such as the center) inside the image 24A and a reference position (such as the center) inside the image 24B. Note that the candidate group 30 of storage locations may also be displayed prior to the candidate group 28.

(Examples of Positions Near a File)

Hereinafter, examples of positions near a file where file format candidates and storage location candidates are displayed will be described.

FIG. 18 illustrates one such example. In the example illustrated in FIG. 5, the candidate group 28 is displayed without overlapping the image 24B of the file B. In contrast, in the example illustrated in FIG. 18, the candidate group 28 is displayed overlapping the image 24B of the file B. In this way, a candidate group may be displayed overlapping the image of a file to be combined. Similarly, the candidate group 30 of storage locations may also be displayed overlapping the image of a file.

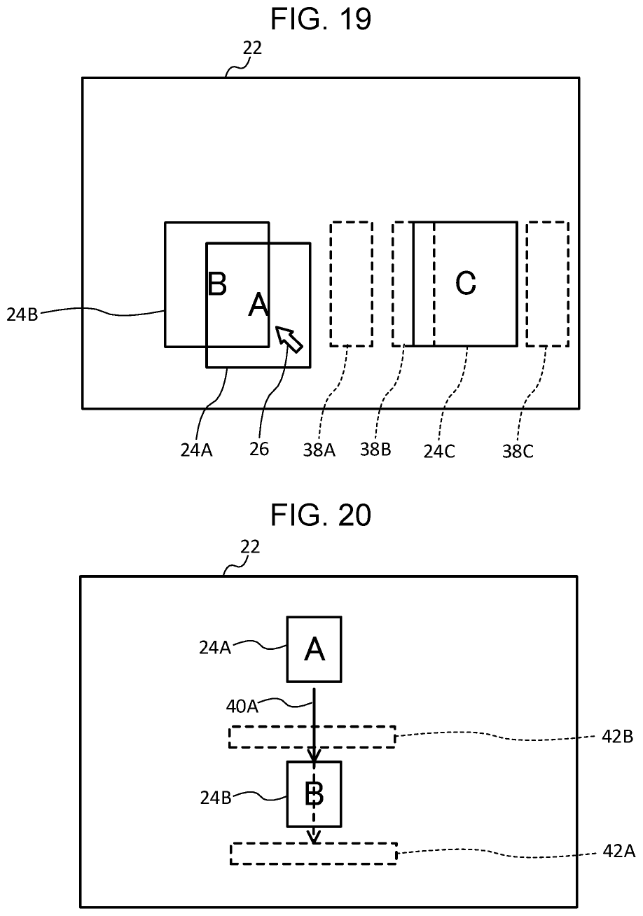

FIG. 19 illustrates another example. In the example illustrated in FIG. 19, the image 24A of the file A is made to overlap the image 24B of the file B, and the files A and B are combined. Also, on the screen 22, an image 24C of a file C is displayed beside the image 24B of the file B. In this situation, the processor 20 displays the candidate group 28 of file formats inside a region 38A between the image 24B of the file B and the image 24C of the file C. The region 38A is region that does not overlap the images 24B and 24C. The file format candidates are displayed next to each other vertically or horizontally inside the region 38A.

As yet another example, the candidate group 28 of file formats may also be displayed inside a region 38B facing the image 24B of the file B in the image 24C of the file C. All or part of the region 38B overlaps the image 24C.

Note that the candidate group 28 is not displayed in a region 38C across the image 24C adjacent to the image 24B, on the side of the image 24C opposite from the image 24B.

FIG. 20 illustrates yet another display example. In the example illustrated in FIG. 20, the file A is operated and combined with the file B. For example, as indicated by the arrow 40A, the user moves the image 24A of the file A on the screen 22 to overlap the image 24B of the file B. Specifically, the user drags the image 24A to the image 24B. In this case, the processor 20 displays the candidate group 28 of file formats at a position (for example, a region 42A) ahead in the operation direction (that is, the movement direction of the image 24A (for example, the direction indicated by the arrow 40A)). The region 42A is a region on the side of the image 24B of the file B opposite from the image 24A of the file A. The region 42A may be a region that does not overlap with the image 24B, or part or all of the region 42A may overlap the image 24B. By displaying the candidate group 28 in the region 42A, the user is able to move the image 24A to the image 24B, and then select an intended candidate from among the candidate group 28 without changing the movement direction (that is, the operation direction). For example, the user is able to select the intended candidate without changing the direction of the drag operation by the mouse. Hypothetically, if the candidate group 28 were displayed in a region 42B between the image 24A and the image 24B, the user would have to move the image 24A to the image 24B and then select a candidate by changing the operation direction to the opposite direction of the movement direction. For example, the user would have to select the intended candidate by reversing the direction of the drag operation by the mouse. If the candidate group 28 is displayed in the region 42A, the user is able to select the intended candidate without reversing the operation direction.

Note that the processor 20 may also display, in the region 42B, the candidates of file formats that do not support the file format of a file to be combined and cannot be converted from that file format.

In the candidate group 28, the processor 20 may also display the candidates of file formats that do not support the file format of a file to be combined distinctly from the candidates of file formats that support the file format of a file to be combined. For example, the processor 20 may cause the images representing the candidates of file formats that do not support the file format of a file to be combined to be displayed grayed out, reduced in size, or displayed with a mark (such as an X symbol) indicating that the file format is unusable. In addition, the processor 20 may also display the reason why the file format is unusable. To explain in terms of a specific example, in the case where an executable file (for example, an exe file) is selected as a file to be combined, the processor 20 causes the candidates of file formats that cannot be converted to or from an executable file (such as PDF) to be grayed out or the like.

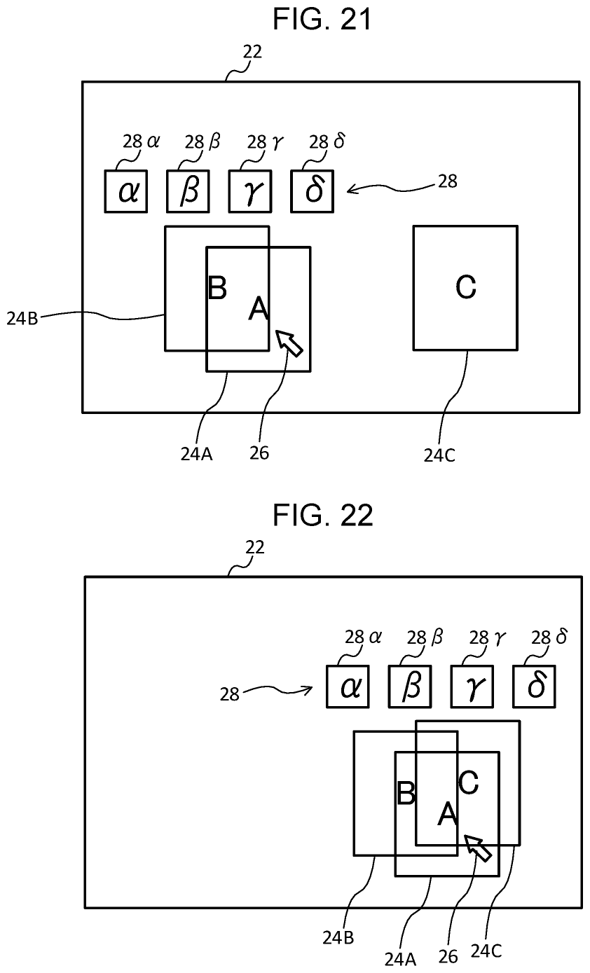

(Process in case of combining three or more files) Hereinafter, FIGS. 21 and 22 will be referenced to describe the case of combining three or more files. FIGS. 21 and 22 illustrate the screen 22.

In the case of combining three or more files, the three or more files are also combined by the same process as the case of combining two files. Hereinafter, the case of combining three files will be described, but a similar process is also executed in the case of combining four or more files.

As illustrated in FIG. 22 for example, if the image 24A of the image A is made to overlap the image 24B of the file B, the candidate group 28 of file formats is displayed near the image 24B. Next, as illustrated in FIG. 23, if the images 24A and 24B are made to overlap the image 24C of the file C without selecting a file format candidate from among the candidate group 28, the candidate group 28 is displayed near the image 24C. In other words, if the file C to be combined is selected before combining the files A and B, the candidate group 28 is displayed near the image 24C. If the intended file format is selected by the user from among the candidate group 28, a combined file in the intended file format is generated on the basis of the files A, B, and C. Like the exemplary embodiment described above, the candidates included in the candidate group 28 and the candidates displayed with priority may also be changed according to the file formats of the files A, B, and C. Additionally, after the combined file is generated, the candidate group 30 of storage locations is displayed. In this case, the candidates included in the candidate group 30 and the candidates displayed with priority may also be changed according to the names of the files A, B, and C.

As another example, after the files A and B are combined to generate the combined file AB, the combined file AB and the file may be combined. For example, if the image of the combined file AB is made to overlap the image 24C of the file C, the candidate group 28 is displayed near the image 24C. The same also applies to the candidate group 30 of storage locations.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
display, in a case where a plurality of files displayed on a display are selected, candidates of an attribute of a combined file generated by combining the plurality of files near the selected files; and
execute, in a case where the attribute is selected, a process related to the selected attribute on the combined file.

2. The information processing device according to claim 1, wherein
the attribute is a file format,
the candidates of the attribute are candidates of the file format of the combined file, and
in a case where the file format treated as the attribute is selected,
the processor is configured to generate the combined file in the selected file format on a basis of the plurality of files.

3. The information processing device according to claim 2, wherein
the processor is configured to change the candidates of the file format of the combined file according to the file format of each of the plurality of files.

4. The information processing device according to claim 3, wherein
in a case where the plurality of files have respectively different file formats,
the processor is configured to display information indicating a file format that merges the plurality of files while maintaining the file format of each of the plurality of files as information indicating a candidate of the file format of the combined file.

5. The information processing device according to claim 3, wherein
in a case where the plurality of files have the same file format,
the processor is configured to display information indicating a file format that merges the plurality of files into a single file as information indicating a candidate of the file format of the combined file.

6. The information processing device according to claim 2, wherein
the processor is configured to change the candidates of the file format of the combined file according whether or not file-related information is attached to each of the plurality of files.

7. The information processing device according to claim 6, wherein
in a case where file-related information is attached to each of the plurality of files, the processor is configured to display information indicating a file format in which the file-related information is not overwritten by other file-related information in a case where a combined file is generated on a basis of the plurality of files as information indicating a candidate of the file format of the combined file.

8. The information processing device according to claim 1, wherein
the attribute is a storage location of the combined file,
the candidates of the attribute are candidates of the storage location of the combined file, and
the processor is configured to store the combined file in a selected storage location.

9. The information processing device according to claim 8, wherein
the processor is configured to change the candidates of the storage location according to names of the plurality of files.

10. The information processing device according to claim 1, wherein
the plurality of files include a first file and a second file, and
the processor is configured to display the candidates of the attribute in a case where the first file is moved to the second file on the display.

11. The information processing device according to claim 2, wherein
the plurality of files include a first file and a second file, and
the processor is configured to display the candidates of the attribute in a case where the first file is moved to the second file on the display.

12. The information processing device according to claim 3, wherein
the plurality of files include a first file and a second file, and
the processor is configured to display the candidates of the attribute in a case where the first file is moved to the second file on the display.

13. The information processing device according to claim 4, wherein
the plurality of files include a first file and a second file, and
the processor is configured to display the candidates of the attribute in a case where the first file is moved to the second file on the display.

14. The information processing device according to claim 5, wherein
the plurality of files include a first file and a second file, and
the processor is configured to display the candidates of the attribute in a case where the first file is moved to the second file on the display.

15. The information processing device according to claim 6, wherein
the plurality of files include a first file and a second file, and
the processor is configured to display the candidates of the attribute in a case where the first file is moved to the second file on the display.

16. The information processing device according to claim 7, wherein
the plurality of files include a first file and a second file, and
the processor is configured to display the candidates of the attribute in a case where the first file is moved to the second file on the display.

17. The information processing device according to claim 10, wherein
the processor is configured to execute the process related to the attribute in a case where the file is made to overlap the second file and then the first file and the second file are made to overlap the information indicating a candidate of the attribute.

18. The information processing device according to claim 10, wherein
the processor is configured to display the candidates of the attribute at a position ahead in an operation direction of the first file.

19. The information processing device according to claim 1, wherein
the attribute is a file format and a storage location,
the plurality of files include a first file and a second file, and
the processor is configured to:
display candidates of the file format of the combined file near the second file in a case where the first file is moved to the second file on the display;
generate, in a case where the file format treated as the attribute is selected, the combined file in the selected file format on a basis of the first file and the second file, and display the combined file;
display candidates of the storage location of the combined file near the displayed combined file; and
store, in a case where the storage location treated as the attribute is selected, the combined file in the selected storage location.

20. A non-transitory computer readable medium storing a program causing a computer to execute a process for processing information, the process comprising:
displaying, in a case where a plurality of files displayed on a display are selected, candidates of an attribute of a combined file generated by combining the plurality of files near the selected files; and
executing, in a case where the attribute is selected, a process related to the selected attribute on the combined file.
